(19) United States
(12) Patent Application Publication
(10) Pub. No.: US 2017/0069037 A1
(43) Pub. Date: Mar. 9, 2017

(54) PROVIDING GRAPHICAL USER INTERFACES FOR SKILL FLOWS

(71) Applicant: Linkedln Corporation, Mountain View, CA (US)

(72) Inventors: Junghoon (Andrew) Ahn, Cupertino, CA (US); Wenjing Zhang, Menlo Park, CA (US); Kuisong Tong, San Jose, CA (US)

(21) Appl. No.: 14/845,483

(22) Filed: Sep. 4, 2015

(51) Int. Cl. G06Q 50/00; G06Q 10/10; H04L 29/08

(52) U.S. Cl. CPC G06Q 50/01; H04L 67/306; G06Q 10/1053

(57) ABSTRACT

Disclosed in some examples are methods, systems, and machine-readable mediums which determine the flow of skills from one entity to another over a given time period and display those in an advanced graphical user interface display. Example entities for which skill flow may be determined may include geographical locations, companies, universities, and the like. The social networking system may determine skill flows based upon the skills associated with members who report changes in employment.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### TECHNICAL FIELD

Embodiments pertain to improved graphical user interfaces and notifications. Some embodiments relate to improved graphical user interfaces and notifications including skill flows.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an illustrated skill flow diagram according to some examples of the present disclosure.

FIG. 2 shows a flowchart of a method of providing an enhanced graphical user interface with skills flow information according to some examples of the present disclosure.

FIG. 3 shows an example graphical user interface for illustrating skill flow according to some examples of the present disclosure.

FIG. 4 is a block diagram illustrating an example of a machine upon which one or more embodiments may be implemented.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. The present inventive subject matter is generally applicable to a wide range of information and networked services. For example, online job boards where users can view or post resumes and employers can post job openings.

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

As part of their member profiles, members may include information on their current position of employment. Information on their current position includes their title, company, geographic location, industry, and periods of employment. The social networking service may also track skills that members possess and when they learned those skills. Skills may be automatically determined by the social networking service based upon member profile attributes of the member, or may be manually entered by the member. Many social networking services are approaching many millions of members. As a result, the member profile data of these networks may offer increased insights on movement of skills over time.

Disclosed in some examples are methods, systems, and machine-readable mediums which determine the flow of skills from one entity to another over a given time period and display those in a graphical user interface display. Example entities for which skill flow may be determined may include geographical locations, companies, universities, and the like. The social networking system may determine skill flows based upon skills associated with members who report changes in employment. The entities (e.g., company, geographical location, and the like) corresponding to the member's old position of employment prior to the change of position loses the skills of the member, and the entities corresponding to the member's new position of employment gains those skills. Thus the skills of the member flow from the entities corresponding to the old position to entities corresponding to the new position. The social networking service may aggregate these flows across all members who report changes in employment position for a particular time period and calculate a skills flow describing the movement of skills to and/or from one entity to another. These changes may provide data for improved graphical user interfaces that visualize the flow of skills into or out of an entity.

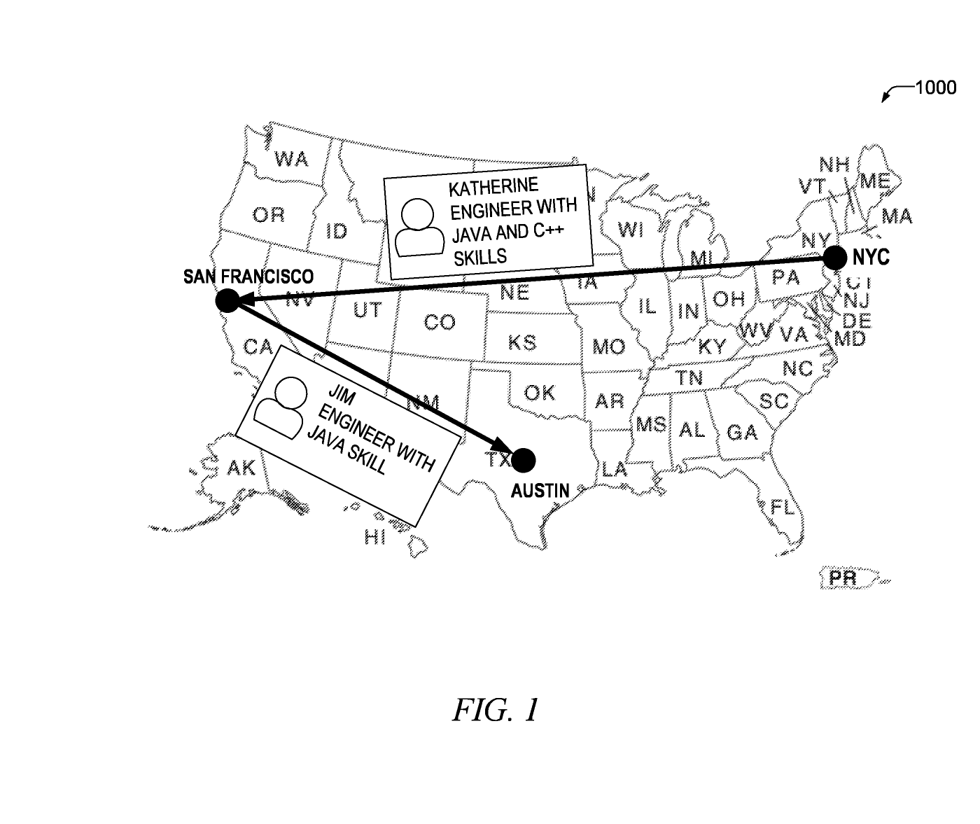

Turning now to FIG. 1, an illustrated skill flow diagram 1000 is provided according to some examples of the present disclosure. In the Figure, Katherine 1010, an engineer, moved from New York City to San Francisco during a particular time period. Jim 1020, also an engineer moved to Austin Texas from San Francisco during the same time period. Strictly counting job flows, San Francisco had a net engineering job flow in this Figure of 0. This is not the complete picture however as it does not take into account the expertise these people have. In the example of FIG. 1, Katherine has skills of JAVA and C++, whereas Jim is only skilled in Java. When skills are factored in, San Francisco experienced an outflow of 1 person experienced in Java, and an inflow of 1 person experienced in Java, for a net Java skill flow of 0. However, San Francisco experienced a net skill flow of +1 for persons skilled in C++ as Katherine moved in and no other members moved out that had a C++ skill. Thus, when using skill flows as a metric as opposed to job flows, a more accurate picture of the flow of expertise from one area to another emerges. In the example of FIG. 1, San Francisco gained additional expertise. Skill flows provides a more detailed view of what talents are moving and where they are moving from and where they are going to from traditional job flow metrics.

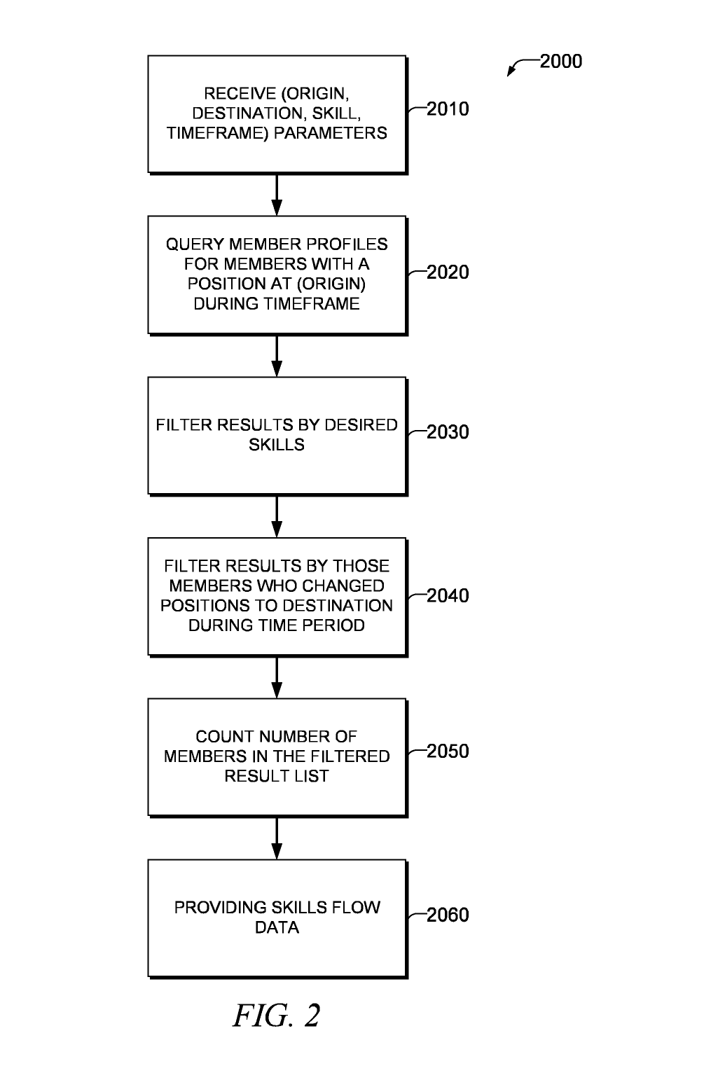

Turning now to FIG. 2, a method 2000 of providing an enhanced graphical user interface with skills flow information according to some examples of the present disclosure is shown. At operation 2010, the system may receive parameters for display of the skill flow. The system may receive one or more of: an origin and a destination, a skill, and a time period. The origin specifies a source entity of individuals with the specified skill. The destination specifies a destination entity of individuals with the specified skill. The origin and destination may be a geographic region, company, educational institution or the like. In examples in which the source and destination are geographical regions, those geographical regions may be any desired granularity, such as a country, state, region, province, territory, city, or the like. The origin and destination specify the direction of skill flow the system is determining (skills move from the origin to the destination entity). In some examples, the origin specified may be multiple origins. In yet other examples, the origins may be specified as all possible origins. For example, the system may determine the skills flow from any origin to the specified destination. Likewise, the destination may also include one or more destinations, and in some examples all destinations. In these examples, the system determines the skills flow from the origin to any destinations.

The skill parameter specifies which skill of a plurality of predetermined skills that the system is to determine a skill flow. In some examples, one or more particular skills may correspond to an industry and selecting an industry may select each skill corresponding to that industry. The time period describes the time period in which the skill flow is measured. The time period may be specified by both a starting point and a duration. The duration may be any unit of time, such as a minute, hour, day, week, month, quarter, year, and the like. The starting point may be specified as an absolute start (e.g., May 5, 2015) or a starting point relative to another time (2 weeks ago).

These parameters may be selected by a user. For example, a graphical user interface may be displayed which may present the user with inputs which may allow the user to select these parameters. In other examples, the social networking service may determine the parameters. For example, the social networking service may determine a display of skill flow for a variety of predetermined origins, destinations, skills and time periods.

At operation 2020, the social networking service may query a database of member profiles for members with a position that meets the criteria of being at the origin (either company, geographic region, or the like) during the time period. At operation 2030, the set of results may then be filtered based upon the selected skills. That is, members in the set of results that do not have the skill during the time period are filtered out. In order to determine when a member obtained a particular skill, a timestamp associated with when they added or learned a skill may be added to their member profiles for this purpose.

At operation 2040, the social networking service may further filter the results to only include members who changed positions from the origin to the destination during the time period. At operation 2050, the number of members in this filtered result list is counted and this number becomes the skill flow from the source to the destination for the specified skill during the time period (an outflow of skills). In some examples, the system may calculate a skill flow in the reverse direction for the time period in the same way (an inflow of skills). The difference between the inflow and outflow is a net skill flow between the origin and the destination.

At operation 2060, the social networking service may then provide a graphical user interface illustrating the skills flow. The graphical user interface may provide the user with the inflow, outflow, or net skill flows for one or more of the source and/or destination for the skill.

In some examples, the expertise of a member in a particular skill may be reflected in the calculation of the skill flows. One way of measuring expertise is the number of endorsements the member has for the particular skill. Endorsements are positive affirmations from other members that the endorsed member has the skill. In these examples, rather than the member counting for +1 for the destination and −1 for the origin for each skill, the member counts per the number of endorsements for a skill. For example, if John moves to San Francisco during the time period and he is skilled in Java and has 4 endorsements and Jane moves from San Francisco during the same time period and has 5 endorsements for Java, the skill flow of Java for San Francisco is −1. In other examples, skill ranges may be utilized to assign a smaller number of points (or some other arbitrary number). For example, if the user has 1-10 endorsements for the skill, they count as 1 point, if the user has 11-20 endorsements for the skill they count as 2 points, and so on.

In still other examples, the endorsements themselves may be weighted. For example, endorsements from members who themselves were endorsed by a large number of members may count more (e.g., be weighted heavier) in the skills flow calculation. For example, each endorsement may count as 1 point multiplied by the number of endorsements the endorser has for that skill divided by the average number of endorsements for each skill. The individual's score for that skill may then be the summation of all the individual scores for each endorser for the skill. For example, suppose that John leaves San Francisco during the time period and has two endorsements. The first, is from Jill, who herself has one endorsement for Java. The second endorsement for John is Jack, who has one endorsement for Java. If the average number of endorsements for Java is 5, then John counts for (1*⅕+1* ⅕)=−0.4 points for Java for San Francisco. Assume Jane arrives in San Francisco during the time period, and she has only one endorsement from Jim. Jim however is endorsed by 10 other members for Java. Jane's contribution to the skill flow for San Francisco is (1* 10/5)=+2. So San Francisco had a net increase in Java skills of +1.6.

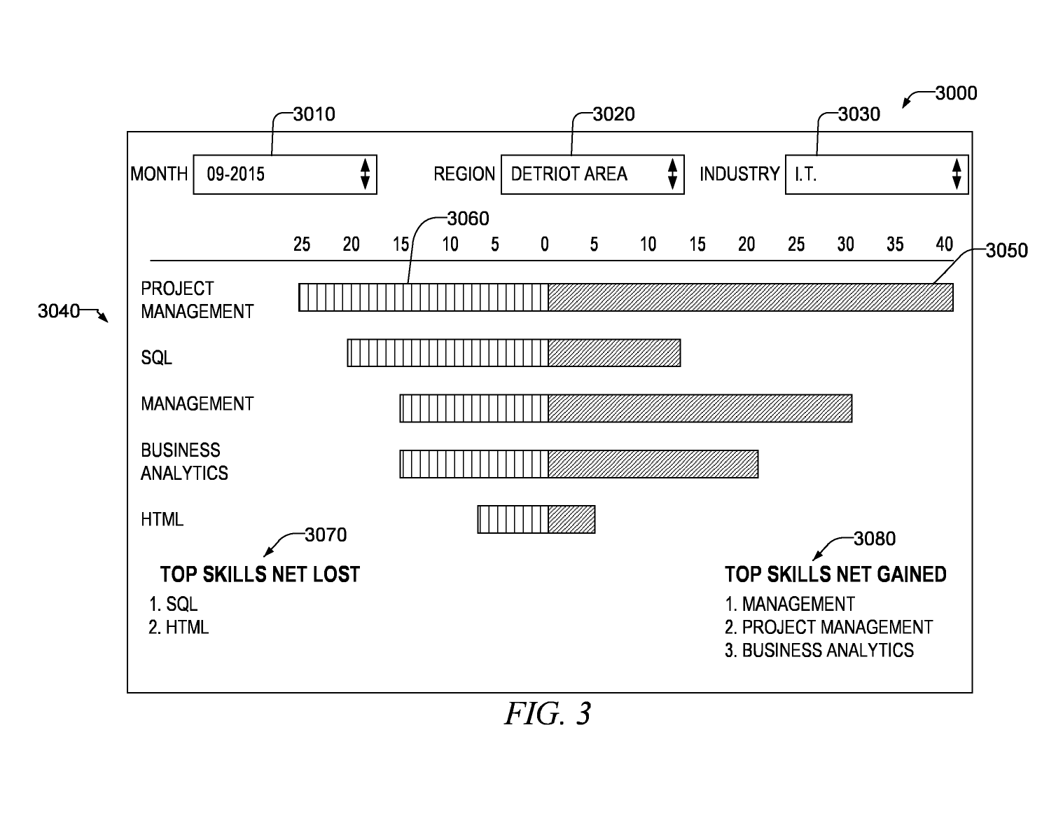

FIG. 3 shows an example graphical user interface for illustrating skill flow 3000 according to some examples of the present disclosure. A time period is selected 3010 from a drop down box containing a number of time period options. A region selection 3020 is also selected from a drop down box. In this example, a geographical region of the “greater Detroit area” is shown. In these examples, the system may run two different queries—one with the origin as the greater Detroit area and the destination as any area, and one with the source as any area and the destination as Detroit. An industry is selected 3030 corresponding to information technology. Selecting information technology runs the query for skills corresponding to information technology. Skills associated with information technology are displayed at 3040. The inflow skill flow is shown by the diagonally striped bars to the right and the outflow skill flow is shown by the vertically striped bars to the left. For example, FIG. 3 shows a bar 3050 which illustrates that 40 members with a “project management” skill moved to the Detroit area in September of 2015 and a bar 3060 that illustrates that 25 members with “project management” skills moved away during the same time period (for a net increase of 15 members). As shown in FIG. 3, both the bars move away from zero in opposite directions. Additionally, at 3070, the top skills net lost and at 3080, the top skills net gained are listed.

Other visualizations may be presented, including heat maps, which display different colors depending on skill flow—for example, areas with the largest net increase in a skill may be a first color on a color spectrum and areas with the largest net loss of a skill may be a second color on the opposite end of the spectrum. Various areas in-between these extremes may be shown in colors moving along the continuum depending on their net skill flow for the skill.

Other uses for skill flow may include company notifications. For example, companies may be notified when their company's, or another company's, skill flow for a particular skill exceeds a predetermined threshold. In other examples, the company may be presented with a skill flow showing one or more of inflow, outflow, and net flow of a plurality of skills corresponding to the industry of the company. Notifications may be for any desired (origin, destination, skill, time period) combination.

In some examples, the skill flow may allow for a determination of skill Liquidity—e.g., how liquid the job market is for persons who possess a particular skill. For example, skills with high inflow AND outflow rates between companies have a high liquidity. For example, if the inflow and outflow rates between companies exceeds a predetermined threshold over a predetermined period of time, the skill flow may be said to be liquid. The social networking service may determine skills with high and low liquidity and may present those skills in one or more graphical user interfaces.

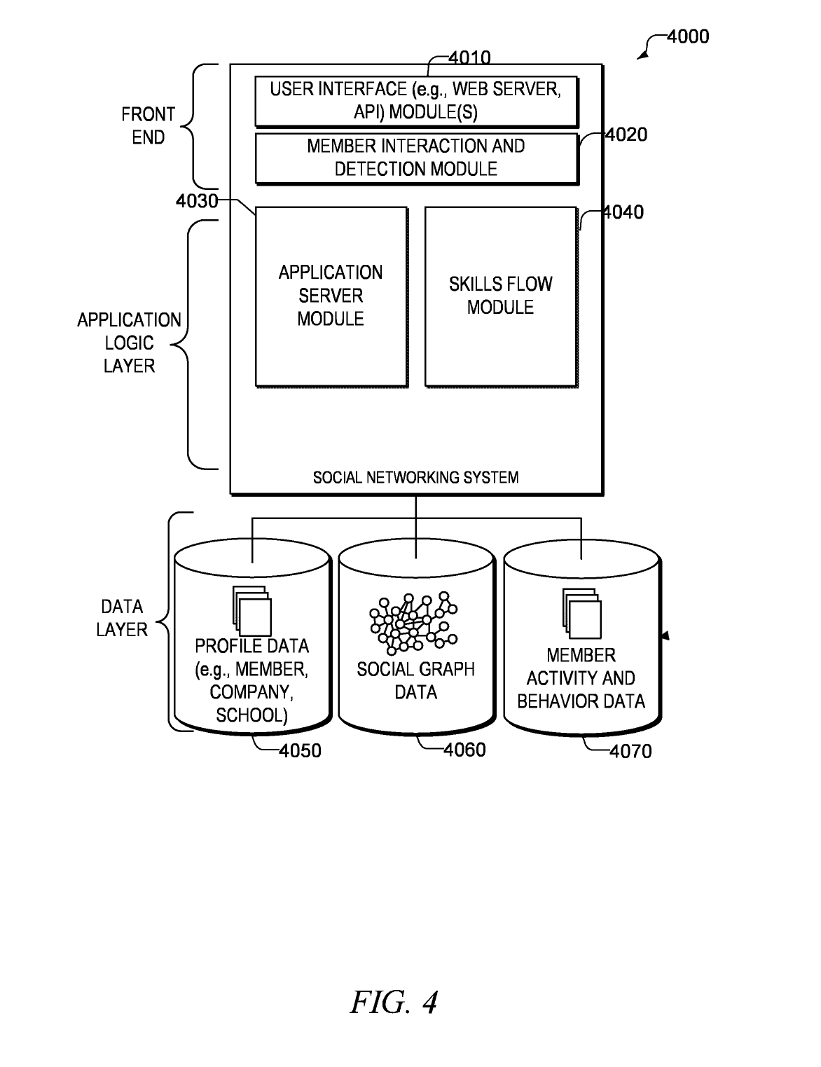

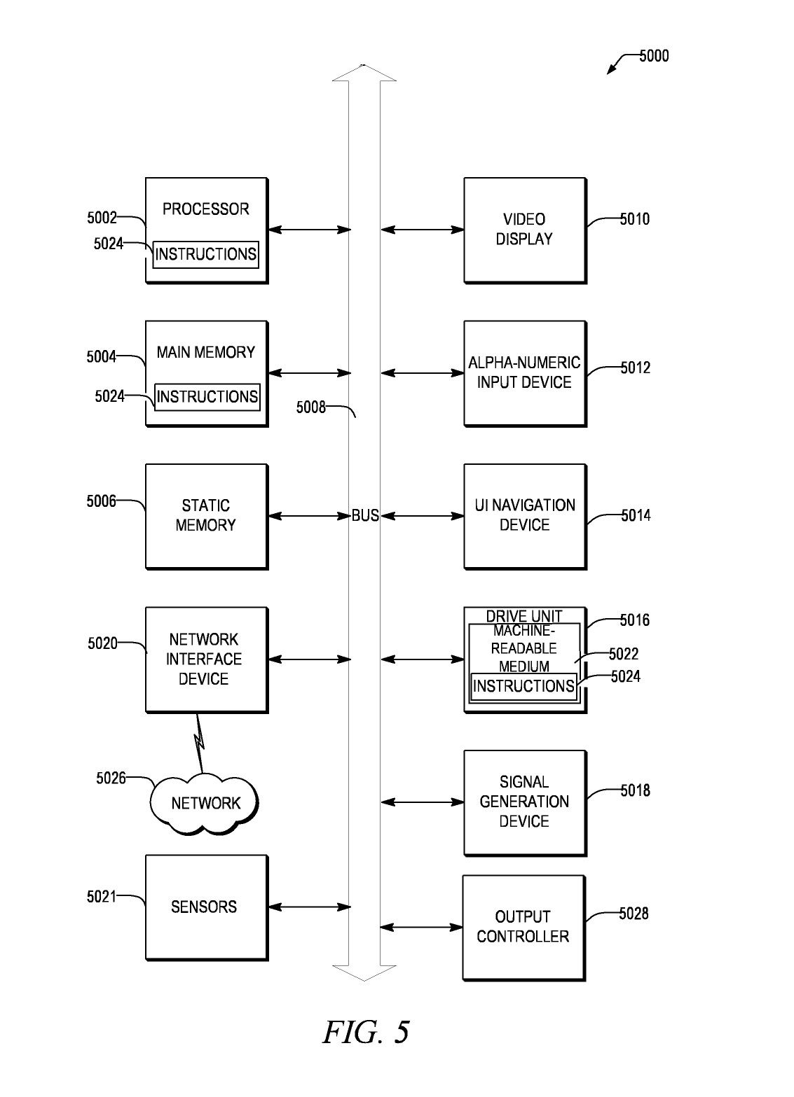

FIG. 4 is a block diagram showing the components of a social networking service 4000. As shown in FIG. 4, a front end may comprise a user interface module (e.g., a web server) 4010, which receives requests from various client-computing devices, and communicates appropriate responses to the requesting client devices. For example, the user interface module(s) 4010 may receive requests in the form of Hypertext Transport Protocol (HTTP) requests, or other network-based, application programming interface (API) requests (e.g., from a dedicated social networking service application running on a client device). In addition, a member interaction and detection module functional 4020 may be provided to detect various interactions that members have with different applications, services and content presented. As shown in FIG. 4, upon detecting a particular interaction, the member interaction and detection module 4020 logs the interaction, including the type of interaction and any meta-data relating to the interaction, in the member activity and behavior database 4070.

An application logic layer may include one or more various application server modules 4030, which, in conjunction with the user interface module(s) 4010, generate various graphical user interfaces (e.g., web pages) with data retrieved from various data sources in the data layer. With some embodiments, application server module 4030 is used to implement the functionality associated with various applications and/or services provided by the social networking service as discussed above.

Application layer may also include skills flow module 4040 which may query profile data stored in profile data database 4050 to determine skills flow based upon user input. Additionally skills flow module 4040 may provide one or more graphical user interfaces for displaying skills flows in conjunction with the application server module 4030 and user interface modules 4010. These graphical user interfaces may include graphical user interfaces for selecting skill flow parameters, and for displaying the results. Skills flow module 4040 may implement the method steps of FIG. 2.

The social networking service 4000 may include a data layer that may include several other databases, such as a database 4050 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 4050. Similarly, when a representative of an organization initially registers the organization with the social networking service, the representative may be prompted to provide certain information about the organization. This information may be stored, for example, in the database 4050, or another database (not shown). With some embodiments, the profile data may be processed (e.g., in the background or offline) to generate various derived profile data. For example, if a member has provided information about various job titles that the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 4060. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 4 by the member activity and behavior database 4070.

With some embodiments, the social networking system 4000 provides an application programming interface (API) module with the user interface module 4010 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

FIG. 5 illustrates a block diagram of an example machine 5000 upon which any one or more of the techniques (e.g., methodologies) discussed herein may perform. In alternative embodiments, the machine 5000 may operate as a standalone device or may be connected (e.g., networked) to other machines. In a networked deployment, the machine 5000 may operate in the capacity of a server machine, a client machine, or both in server-client network environments. In an example, the machine 5000 may act as a peer machine in peer-to-peer (P2P) (or other distributed) network environment. The machine 5000 may be or include computing devices for executing the methods of FIG. 2, producing the graphical user interfaces of FIGS. 1, 3, and be or contain the logical modules of FIG. 4. The machine 5000 may be a server, a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 5000 may include a hardware processor 5002 (e.g., a central processing unit (CPU), a graphics processing unit (GPU), a hardware processor core, or any combination thereof), a main memory 5004 and a static memory 5006, some or all of which may communicate with each other via an interlink (e.g., bus) 5008. The machine 5000 may further include a display unit 5010, an alphanumeric input device 5012 (e.g., a keyboard), and a user interface (UI) navigation device 5014 (e.g., a mouse). In an example, the display unit 5010, input device 5012 and UI navigation device 5014 may be a touch screen display. The machine 5000 may additionally include a storage device (e.g., drive unit) 5016, a signal generation device 5018 (e.g., a speaker), a network interface device 5020, and one or more sensors 5021, such as a global positioning system (GPS) sensor, compass, accelerometer, or other sensor. The machine 5000 may include an output controller 5028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 5016 may include a machine readable medium 5022 on which is stored one or more sets of data structures or instructions 5024 (e.g., software) embodying or utilized by any one or more of the techniques or functions described herein. The instructions 5024 may also reside, completely or at least partially, within the main memory 5004, within static memory 5006, or within the hardware processor 5002 during execution thereof by the machine 5000. In an example, one or any combination of the hardware processor 5002, the main memory 5004, the static memory 5006, or the storage device 5016 may constitute machine readable media.

While the machine readable medium 5022 is illustrated as a single medium, the term “machine readable medium” may include a single medium or multiple media (e.g., a centralized or distributed database, and/or associated caches and servers) configured to store the one or more instructions 5024.

The term “machine readable medium” may include any medium that is capable of storing, encoding, or carrying instructions for execution by the machine 5000 and that cause the machine 5000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 5024 may further be transmitted or received over a communications network 5026 using a transmission medium via the network interface device 5020. The Machine 5000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 5020 may include one or more physical jacks (e.g., Ethernet, coaxial, or phone jacks) or one or more antennas to connect to the communications network 5026. In an example, the network interface device 5020 may include a plurality of antennas to wirelessly communicate using at least one of single-input multiple-output (SIMO), multiple-input multiple-output (MIMO), or multiple-input single-output (MISO) techniques. In some examples, the network interface device 5020 may wirelessly communicate using Multiple User MIMO techniques.

What is claimed is:

1. A method comprising:
receiving a selection from a user via a graphical user interface provided to the user by a social networking service, the selection comprising an origin, a destination, a skill, and a time period;
retrieving member profiles of members of the social networking service that held a position corresponding to the origin during the time period;
filtering the retrieved member profiles to include only the member profiles indicating that the respective members corresponding to the retrieved member profiles possessed the skill during the time period;
filtering further the retrieved member profiles to include only those members that changed positions to a position corresponding to the destination during the time period;
counting the number of filtered member profiles to calculate a skill flow from the origin to the destination during the time period; and
providing a graphical user interface to a user of the social networking service including the skill flow.

2. The method of claim 1, wherein the origin and destinations are geographical locations.

3. The method of claim 1, wherein the destination is any geographical area.

4. The method of claim 1, wherein the origin is any geographical area.

5. The method of claim 1, wherein the origin is a company.

6. The method of claim 5, wherein the destination is any company.

7. The method of claim 1, further comprising:
retrieving member profiles of members of the social networking service that held a position corresponding to the destination during the time period;
filtering the retrieved member profiles to include only the member profiles indicating that the respective members corresponding to the retrieved member profiles possessed the skill during the time period;
filtering further the retrieved member profiles to include only those members that changed positions to a position corresponding to the origin during the time period;
counting the number of filtered member profiles to calculate a second skill flow from the destination to the origin during the time period; and
providing the second skill flow in the graphical user interface.

8. The method of claim 7, further comprising:
calculating a net skill flow by subtracting the second skill flow from the skill flow; and
providing the net skill flow in the graphical user interface.

9. A system comprising:
a processor;
a non-transitory computer-readable medium having instructions stored there on, which, when executed by the processor, causes the system to perform the operations of:
receiving a selection from a user via a graphical user interface provided to the user by a social networking service, the selection comprising an origin, a destination, a skill, and a time period;
retrieving member profiles of members of the social networking service that held a position corresponding to the origin during the time period;
filtering the retrieved member profiles to include only the member profiles indicating that the respective members corresponding to the retrieved member profiles possessed the skill during the time period;
filtering further the retrieved member profiles to include only those members that changed positions to a position corresponding to the destination during the time period;
counting the number of filtered member profiles to calculate a skill flow from the origin to the destination during the time period; and
providing a graphical user interface to a user of the social networking service including the skill flow.

10. The system of claim 9, wherein the origin and destinations are geographical locations.

11. The system of claim 9, wherein the destination is any geographical area.

12. The system of claim 9, wherein the origin is any geographical area.

13. The system of claim 9, wherein the origin is a company.

14. The system of claim 13, wherein the destination is any company.

15. The system of claim 9, wherein the operations further comprise:
retrieving member profiles of members of the social networking service that held a position corresponding to the destination during the time period;
filtering the retrieved member profiles to include only the member profiles indicating that the respective members corresponding to the retrieved member profiles possessed the skill during the time period;
filtering further the retrieved member profiles to include only those members that changed positions to a position corresponding to the origin during the time period;
counting the number of filtered member profiles to calculate a second skill flow from the destination to the origin during the time period; and
providing the second skill flow in the graphical user interface.

16. A non-transitory computer-readable medium having instructions stored there on, which, when executed by a machine, causes the machine to perform the operations of:
receiving a selection from a user via a graphical user interface provided to the user by a social networking service, the selection comprising an origin, a destination, a skill, and a time period;
retrieving member profiles of members of the social networking service that held a position corresponding to the origin during the time period;
filtering the retrieved member profiles to include only the member profiles indicating that the respective members corresponding to the retrieved member profiles possessed the skill during the time period;
filtering further the retrieved member profiles to include only those members that changed positions to a position corresponding to the destination during the time period;
counting the number of filtered member profiles to calculate a skill flow from the origin to the destination during the time period; and
providing a graphical user interface to a user of the social networking service including the skill flow.

17. The machine-readable medium of claim 16, wherein the origin and destinations are geographical locations.

18. The machine-readable medium of claim 16, wherein the destination is any geographical area.

19. The machine-readable medium of claim 16, wherein the origin is any geographical area.

20. The machine-readable medium of claim 16, wherein the origin is a company.

21. The machine-readable medium of claim 20, wherein the destination is any company.

22. The machine-readable medium of claim 16, wherein the operations further comprise:
retrieving member profiles of members of the social networking service that held a position corresponding to the destination during the time period;
filtering the retrieved member profiles to include only the member profiles indicating that the respective members corresponding to the retrieved member profiles possessed the skill during the time period;
filtering further the retrieved member profiles to include only those members that changed positions to a position corresponding to the origin during the time period;
counting the number of filtered member profiles to calculate a second skill flow from the destination to the origin during the time period; and
providing the second skill flow in the graphical user interface.
